(19) United States
(12) Patent Application Publication
(10) Pub. No.: US 2013/0187916 A1
(43) Pub. Date: Jul. 25, 2013

(54) SYSTEM AND METHOD FOR COMPRESSION AND SIMPLIFICATION OF VIDEO, PICTORIAL, OR GRAPHICAL DATA USING POLYGON REDUCTION FOR REAL TIME APPLICATIONS

(71) Applicants: Gregory K. Toy, Tucson, AZ (US); Luke K. Stewart, Sahuarita, AZ (US)

(72) Inventors: Gregory K. Toy, Tucson, AZ (US); Luke K. Stewart, Sahuarita, AZ (US)

(73) Assignee: Raytheon Company, Waltham, MA (US)

(21) Appl. No.: 13/357,851

(22) Filed: Jan. 25, 2012

(51) Int. Cl. G06T 17/00

(52) U.S. Cl. 345/420

(57) ABSTRACT

A system and method translate a model in computer aided design (CAD) format into a lightweight format. The lightweight format includes a plurality of polygons. The lightweight format is received into an animation tool. The animation tool combines the polygons of the lightweight format into a reduced mesh, and optimizes the reduced mesh by reducing a count of the polygons in the model. The reduced mesh is exported into the lightweight format for use in 3D real time applications.

### TECHNICAL FIELD

The current disclosure relates to a system and method for the compression and simplification of video, pictorial, and graphic data, and in an embodiment, but not by way of limitation, a use of polygon reduction for real time applications.

### BACKGROUND

Complex digital 3D geometry generated by computer aided design (CAD) programs is increasingly being used in a variety of different ways not commonly associated with traditional applications. While this can expand the usefulness of such CAD programs, it can also lead to interoperability issues and slow performance when viewed in stereoscopic 3D and real time applications.

### BRIEF DESCRIPTION OF THE DRAWINGS

FIGS. 1A and 1B are a diagram of an example process to reduce the number of polygons for a real time application.

FIG. 2 is a block diagram of an example embodiment of a computer processor system in connection with which embodiments of the current disclosure can execute.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

In an embodiment, a process provides computer aided design (CAD) interoperability amongst a variety of software applications while simultaneously compressing and simplifying geometry for usage in graphical processing unit (GPU) intensive applications (e.g., stereoscopic 3D, rendering, and video game development). This is a unique process and product, since traditionally there has been very little overlap between CAD design and pure visualization.

A series of different software tools are used in a novel and unique way to create an output that each individual commercial off the shelf (COTS) software package was not originally designed to generate. First, a user begins with a CAD format from a mechanical, computer aided design model (e.g., a PTC Pro/ENGINEER CAD tool). A goal is to reduce the extremely large and complex CAD file to a single item with fewer polygons. This will lead to increased performance of a virtual reality system while allowing previously non-viewable models to be displayed.

Second, the 3D CAD model is translated into a lightweight format. In an embodiment, the lightweight format is a .JT format, and the translation is performed by a Siemens JT translator. Third, an animation tool is opened. For example, a user could employ an Autodesk 3d Studio Max animation tool. Fourth, the lightweight file is imported into the animation tool. The importation can use an Okino PolyTrans software tool. Fifth, all pieces of the geometry of the lightweight format are combined together into a single mesh. This combination can be accomplished using a 3DS Max “Attach List” function. Sixth, the meshed geometry is optimized by reducing the polygon count on the entire model at once. This reduction can be accomplished using the 3DS Max ProOptimizer function.

Seventh, the optimized geometry is exported into the .JT format for display in stereoscopic 3D in a Virtual Reality or similar application. This process is different from how such software applications are used in industry, and further different from how other industries create visual data. Specifically, other industries generally start from scratch to create low polygon models for use in dynamic simulations (as in common in the gaming industry) or for stunning visual animations (as is typical in the entertainment industry).

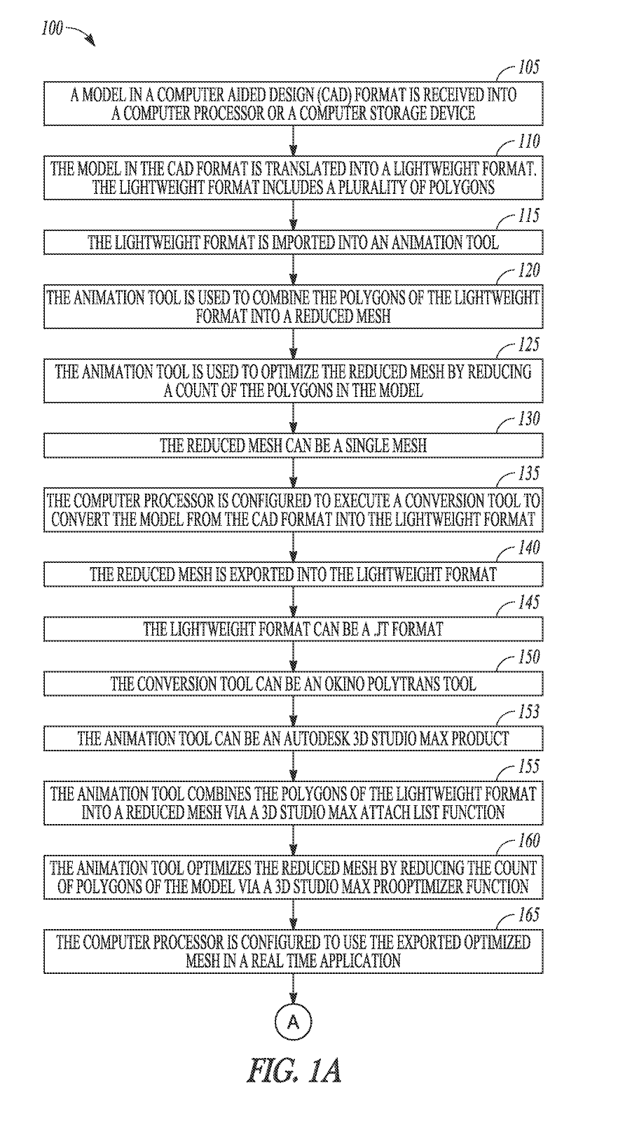

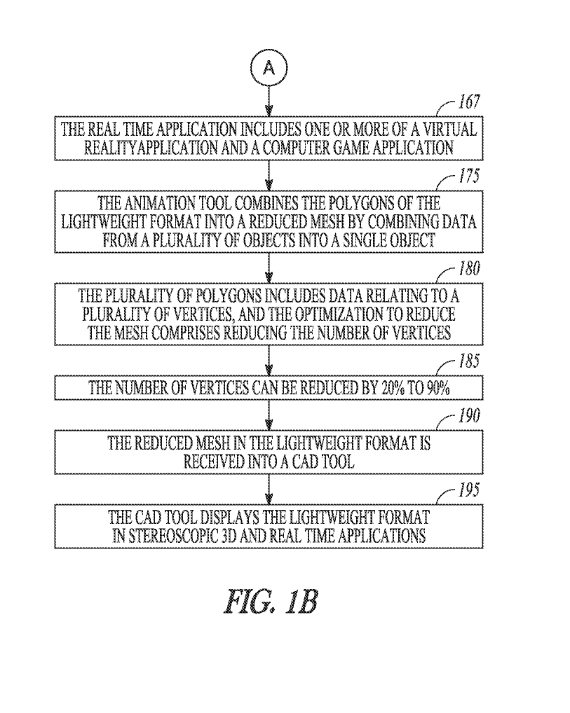

FIGS. 1A and 1B are a diagram of an example process 100 for the use of polygon reduction for real time applications. FIGS. 1A and 1B include a number of process blocks 105-195. Though arranged serially in the example of FIGS. 1A and 1B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIGS. 1A and 1B, at 105, a model in a computer aided design (CAD) format is received into a computer processor or a computer storage device. In general, the computer processor executes software processes that manipulate the CAD format, and the computer storage device stores the CAD format and other converted formats of the model. There may also be some storage functions associated with the processor. At 110, the model in the CAD format is translated into a lightweight format. The lightweight format includes a plurality of polygons. At 115, the lightweight format is imported into an animation tool. At 120, the animation tool is used to combine the polygons of the lightweight format into a reduced mesh. At 125, the animation tool is used to optimize the reduced mesh by reducing a count of the polygons in the model. The reduced mesh can be a single mesh (130).

At 135, the computer processor is configured to execute a conversion tool to convert the model from the CAD format into the lightweight format. At 140, the reduced mesh is exported into the lightweight format. The lightweight format can be a .JT format (145). The conversion tool can be an Okino Polytrans tool (150). The animation tool can be an Autodesk 3D Studio Max product (153). At 155, the animation tool combines the polygons of the lightweight format into a reduced mesh via a 3D Studio Max attach list function. At 160, the animation tool optimizes the reduced mesh by reducing the count of polygons of the model via a 3D Studio Max ProOptimizer function. At 165, the computer processor is configured to use the exported optimized mesh in a real time application, and at 167, the real time application includes one or more of a virtual reality application and a computer game application. At 175, the animation tool combines the polygons of the lightweight format into a reduced mesh by combining data from a plurality of objects into a single object. The plurality of polygons includes data relating to a plurality of vertices, and the optimization to reduce the mesh comprises reducing the number of vertices (180). The number of vertices can be reduced by 20% to 90% (185). At 190, the reduced mesh in the lightweight format is received into a CAD tool, and at 195, the CAD tool displays the lightweight format in stereoscopic 3D and real time applications.

The process outlined in FIGS. 1A and 1B is unique in the fact that it crosses many traditional boundaries within different design organizations. It can be utilized in connection with facilities models, mechanical applications, thermal/structural analysis, electrical board design, and systems engineering presentations. Simply put, anything that requires a polygon reduction in order to view it in stereoscopic 3D can use this method. The process uses multiple steps within commercial off the shelf (COTS) applications or self-generated software to reduce polygon count in 3D models. The process converts complex parametric CAD models into a lightweight visual format.

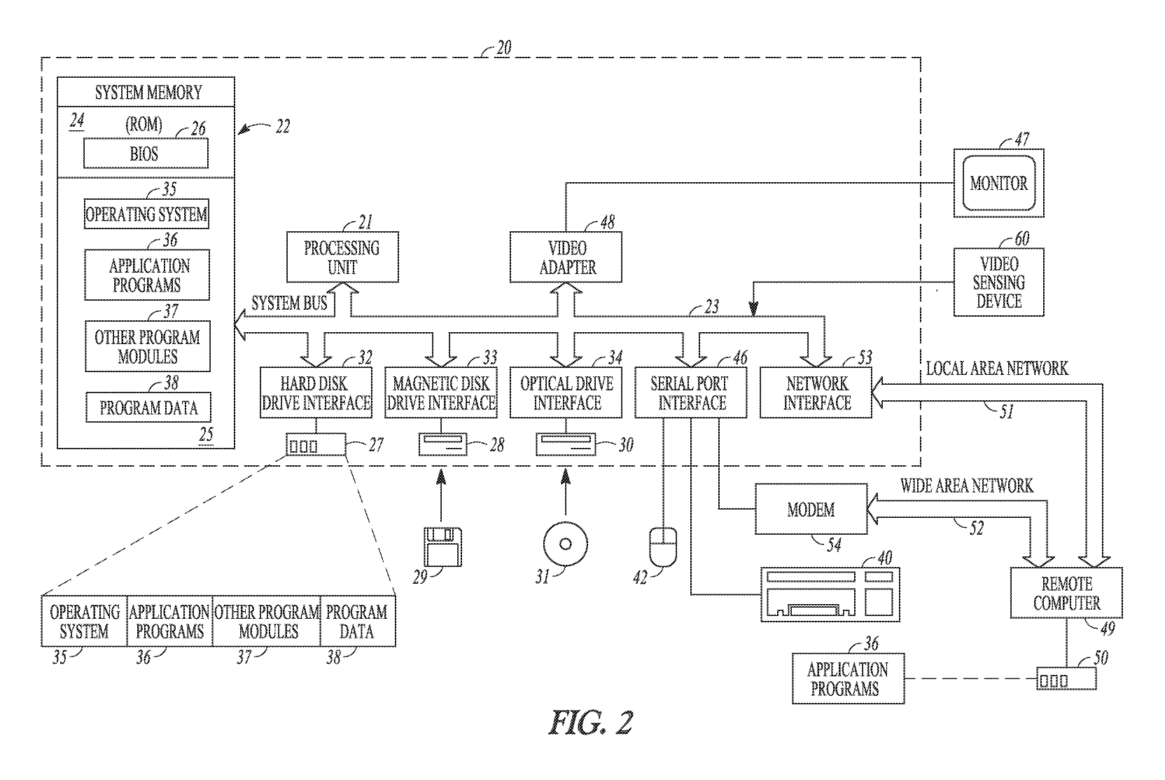

FIG. 2 is an overview diagram of an operating environment in conjunction with which embodiments of the invention may be practiced. The description of FIG. 2 is intended to provide a brief, general description of suitable computer hardware and a suitable computing environment in conjunction with which the invention may be implemented. In some embodiments, the invention is described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computer environments where tasks are performed by I/O remote processing devices that are linked through a communications network. In a distributed computing environment, program modules may be located in both local and remote memory storage devices.

In the embodiment shown in FIG. 2, a hardware and operating environment is provided that is applicable to any of the servers and/or remote clients shown in the other Figures.

As shown in FIG. 2, one embodiment of the hardware and operating environment includes a general purpose computing device in the form of a computer 20 (e.g., a personal computer, workstation, or server), including one or more processing units 21, a system memory 22, and a system bus 23 that operatively couples various system components including the system memory 22 to the processing unit 21. There may be only one or there may be more than one processing unit 21, such that the processor of computer 20 comprises a single central-processing unit (CPU), or a plurality of processing units, commonly referred to as a multiprocessor or parallel-processor environment. A multiprocessor system can include cloud computing environments. In various embodiments, computer 20 is a conventional computer, a distributed computer, or any other type of computer.

The system bus 23 can be any of several types of bus structures including a memory bus or memory controller, a peripheral bus, and a local bus using any of a variety of bus architectures. The system memory can also be referred to as simply the memory, and, in some embodiments, includes read-only memory (ROM) 24 and random-access memory (RAM) 25. A basic input/output system (BIOS) program 26, containing the basic routines that help to transfer information between elements within the computer 20, such as during start-up, may be stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 couple with a hard disk drive interface 32, a magnetic disk drive interface 33, and an optical disk drive interface 34, respectively. The drives and their associated computer-readable media provide non volatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), redundant arrays of independent disks (e.g., RAID storage devices) and the like, can be used in the exemplary operating environment.

A plurality of program modules can be stored on the hard disk, magnetic disk 29, optical disk 31, ROM 24, or RAM 25, including an operating system 35, one or more application programs 36, other program modules 37, and program data 38. A plug in containing a security transmission engine for the present invention can be resident on any one or number of these computer-readable media.

A user may enter commands and information into computer 20 through input devices such as a keyboard 40 and pointing device 42. Other input devices (not shown) can include a microphone, joystick, game pad, satellite dish, scanner, or the like. These other input devices are often connected to the processing unit 21 through a serial port interface 46 that is coupled to the system bus 23, but can be connected by other interfaces, such as a parallel port, game port, or a universal serial bus (USB). A monitor 47 or other type of display device can also be connected to the system bus 23 via an interface, such as a video adapter 48. The monitor 40 can display a graphical user interface for the user. In addition to the monitor 40, computers typically include other peripheral output devices (not shown), such as speakers and printers.

The computer 20 may operate in a networked environment using logical connections to one or more remote computers or servers, such as remote computer 49. These logical connections are achieved by a communication device coupled to or a part of the computer 20; the invention is not limited to a particular type of communications device. The remote computer 49 can be another computer, a server, a router, a network PC, a client, a peer device or other common network node, and typically includes many or all of the elements described above relative to the computer 20, although only a memory storage device 50 has been illustrated. The logical connections depicted in FIG. 2 include a local area network (LAN) 51 and/or a wide area network (WAN) 52. Such networking environments are commonplace in office networks, enterprise-wide computer networks, intranets and the internet, which are all types of networks.

When used in a LAN-networking environment, the computer 20 is connected to the LAN 51 through a network interface or adapter 53, which is one type of communications device. In some embodiments, when used in a WAN-networking environment, the computer 20 typically includes a modem 54 (another type of communications device) or any other type of communications device, e.g., a wireless transceiver, for establishing communications over the wide-area network 52, such as the internet. The modem 54, which may be internal or external, is connected to the system bus 23 via the serial port interface 46. In a networked environment, program modules depicted relative to the computer 20 can be stored in the remote memory storage device 50 of remote computer, or server 49. It is appreciated that the network connections shown are exemplary and other means of, and communications devices for, establishing a communications link between the computers may be used including hybrid fiber-coax connections, T1-T3 lines, DSL's, OC-3 and/or OC-12, TCP/IP, microwave, wireless application protocol, and any other electronic media through any suitable switches, routers, outlets and power lines, as the same are known and understood by one of ordinary skill in the art.

### Example Embodiments

Several embodiments and sub-embodiments have been disclosed above, and it is envisioned that any embodiment can be combined with any other embodiment or sub-embodiment. Specific examples of such combinations are illustrated in the examples below.

Example No. 1 is a system including one or more of a computer processor and a computer storage device. The processor and storage device are configured to receive a model in a computer aided design (CAD) format; translate the model in the CAD format into a lightweight format, the lightweight format comprising a plurality of polygons; receive the lightweight format into an animation tool; use the animation tool to combine the polygons of the lightweight format into a reduced mesh; use the animation tool to optimize the reduced mesh by reducing a count of the polygons in the model; and export the reduced mesh into the lightweight format.

Example No. 2 includes the features of Example No. 1 and optionally includes a system wherein the lightweight format comprises a .JT format.

Example No. 3 includes the features of Example Nos. 1-2 and optionally includes a system wherein the computer processor is configured to execute a conversion tool to convert the model in the CAD format into the lightweight format.

Example No. 4 includes the features of Example Nos. 1-3 and optionally includes a system wherein the conversion tool comprises an Okino Polytrans tool.

Example No. 5 includes the features of Example Nos. 1-4 and optionally includes a system wherein the reduced mesh comprises a single mesh.

Example No. 6 includes the features of Example Nos. 1-5 and optionally includes a system wherein the animation tool comprises an Autodesk 3D Studio Max product.

Example No. 7 includes the features of Example Nos. 1-6 and optionally includes a system wherein the use of the animation tool to combine the polygons of the lightweight format into a reduced mesh comprises use of a 3D Studio Max attach list function.

Example No. 8 includes the features of Example Nos. 1-7 and optionally includes a system wherein the use of the animation tool to optimize the reduced mesh by reducing the count of polygons of the model comprises use of a 3D Studio Max ProOptimizer function.

Example No. 9 includes the features of Example Nos. 1-8 and optionally includes a system wherein the computer processor is configured to use the exported optimized mesh in a real time application.

Example No. 10 includes the features of Example Nos. 1-9 and optionally includes a system wherein the real time application comprises one or more of a virtual reality application and a computer game application.

Example No. 11 includes the features of Example Nos. 1-10 and optionally includes a system wherein a Siemens JT translator translates the model in the CAD format into the lightweight format.

Example No. 12 includes the features of Example Nos. 1-11 and optionally includes a system wherein the use of the animation tool to combine the polygons of the lightweight format into a reduced mesh combines data from a plurality of objects into a single object.

Example No. 13 includes the features of Example Nos. 1-12 and optionally includes a system wherein the plurality of polygons comprises data relating to a plurality of vertices, and the optimization to reduce the mesh comprises reducing the number of vertices.

Example No. 14 includes the features of Example Nos. 1-13 and optionally includes a system wherein the number of vertices is reduced by 20% to 90%.

Example No. 15 includes the features of Example Nos. 1-14 and optionally includes a system wherein the computer processor is configured to transmit the reduced mesh in the lightweight format into a CAD tool.

Example No. 16 includes the features of Example Nos. 1-15 and optionally includes a system wherein the computer processor is configured to use the CAD tool to display the lightweight format in stereoscopic 3D and/or a real time application.

Example No. 17 is a process including receiving into a computer processor a model in a computer aided design (CAD) format; translating the model in the CAD format into a lightweight format, the lightweight format comprising a plurality of polygons; receiving the lightweight format into an animation tool; using the animation tool to combine the polygons of the lightweight format into a reduced mesh; using the animation tool to optimize the reduced mesh by reducing a count of the polygons in the model; and exporting the reduced mesh into the lightweight format.

Example No. 18 is a computer readable storage device comprising instructions that when executed by a processor execute a process including receiving into a computer processor a model in a computer aided design (CAD) format; translating the model in the CAD format into a lightweight format, the lightweight format comprising a plurality of polygons; receiving the lightweight format into an animation tool; using the animation tool to combine the polygons of the lightweight format into a reduced mesh; using the animation tool to optimize the reduced mesh by reducing a count of the polygons in the model; and exporting the reduced mesh into the lightweight format.

Example No. 19 includes the features of Example No. 18 and optionally includes a computer readable storage device comprising instructions for combining data from a plurality of objects into a single object.

Example No. 20 includes the features of Example Nos. 18-19 and optionally includes a computer readable storage device wherein the plurality of polygons comprises data relating to a plurality of vertices, and the optimization to reduce the mesh comprises reducing the number of vertices.

Example No. 21 is a system for compression and simplification of video, pictorial, and graphic data comprising one or more of a computer processor and a computer storage device configured to receive a model in a computer aided design (CAD) format; translate the model in the CAD format into a lightweight format, the lightweight format comprising a plurality of polygons; receive the lightweight format into an animation tool; use the animation tool to combine the polygons of the lightweight format into a reduced mesh; use the animation tool to optimize the reduced mesh by reducing a count of the polygons in the model; export the reduced mesh into the lightweight format; and use the exported mesh in a real time application including one or more of a virtual reality application and a computer game application. The plurality of polygons comprises data relating to a plurality of vertices, and the optimization to reduce the mesh comprises reducing the number of vertices, and the reduced mesh comprises a single mesh.

Example No. 22 includes the features of Example No. 21 and optionally includes a system wherein the use of the animation tool to combine the polygons of the lightweight format into a reduced mesh combines data from a plurality of objects into a single object.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

1. A system comprising:
one or more of a computer processor and a computer storage device configured to:
receive a model in a computer aided design (CAD) format;
translate the model in the CAD format into a lightweight format, the lightweight format comprising a plurality of polygons;
receive the lightweight format into an animation tool;
use the animation tool to combine the polygons of the lightweight format into a reduced mesh;
use the animation tool to optimize the reduced mesh by reducing a count of the polygons in the model; and
export the reduced mesh into the lightweight format.

2. The system of claim 1, wherein the lightweight format comprises a .JT format.

3. The system of claim 1, wherein the computer processor is configured to execute a conversion tool to convert the model in the CAD format into the lightweight format.

4. The system of claim 3, wherein the conversion tool comprises an Okino Polytrans tool.

5. The system of claim 1, wherein the reduced mesh comprises a single mesh.

6. The system of claim 1, wherein the animation tool comprises an Autodesk 3D Studio Max product.

7. The system of claim 1, wherein the use of the animation tool to combine the polygons of the lightweight format into a reduced mesh comprises use of a 3D Studio Max attach list function.

8. The system of claim 1, wherein the use of the animation tool to optimize the reduced mesh by reducing the count of polygons of the model comprises use of a 3D Studio Max ProOptimizer function.

9. The system of claim 1, wherein the computer processor is configured to use the exported optimized mesh in a real time application.

10. The system of claim 9, wherein the real time application comprises one or more of a virtual reality application and a computer game application.

11. The system of claim 1, wherein a Siemens JT translator translates the model in the CAD format into the lightweight format.

12. The system of claim 1, wherein the use of the animation tool to combine the polygons of the lightweight format into a reduced mesh combines data from a plurality of objects into a single object.

13. The system of claim 1, wherein the plurality of polygons comprises data relating to a plurality of vertices, and the optimization to reduce the mesh comprises reducing the number of vertices.

14. The system of claim 13, wherein the number of vertices is reduced by 20% to 90%.

15. The system of claim 1, wherein the computer processor is configured to transmit the reduced mesh in the lightweight format into a CAD tool.

16. The system of claim 15, wherein the computer processor is configured to use the CAD tool to display the lightweight format in stereoscopic 3D or a real time application.

17. A process comprising:
receiving into a computer processor a model in a computer aided design (CAD) format;
translating the model in the CAD format into a lightweight format, the lightweight format comprising a plurality of polygons;
receiving the lightweight format into an animation tool;
using the animation tool to combine the polygons of the lightweight format into a reduced mesh;
using the animation tool to optimize the reduced mesh by reducing a count of the polygons in the model; and
exporting the reduced mesh into the lightweight format.

18. A computer readable storage device comprising instructions that when executed by a processor execute a process comprising:
receiving into a computer processor a model in a computer aided design (CAD) format;
translating the model in the CAD format into a lightweight format, the lightweight format comprising a plurality of polygons;
receiving the lightweight format into an animation tool;
using the animation tool to combine the polygons of the lightweight format into a reduced mesh;
using the animation tool to optimize the reduced mesh by reducing a count of the polygons in the model; and
exporting the reduced mesh into the lightweight format.

19. The computer readable storage device of claim 18, comprising instructions for combining data from a plurality of objects into a single object.

20. The computer readable storage device of claim 18, wherein the plurality of polygons comprises data relating to a plurality of vertices, and the optimization to reduce the mesh comprises reducing the number of vertices.

21. A system for compression and simplification of video, pictorial, and graphic data comprising:
one or more of a computer processor and a computer storage device configured to:
receive a model in a computer aided design (CAD) format;
translate the model in the CAD format into a lightweight format, the lightweight format comprising a plurality of polygons;
receive the lightweight format into an animation tool;
use the animation tool to combine the polygons of the lightweight format into a reduced mesh;
use the animation tool to optimize the reduced mesh by reducing a count of the polygons in the model;
export the reduced mesh into the lightweight format; and
use the exported mesh in a real time application including one or more of a virtual reality application and a computer game application;
wherein the plurality of polygons comprises data relating to a plurality of vertices, and the optimization to reduce the mesh comprises reducing the number of vertices; and
wherein the reduced mesh comprises a single mesh.

22. The system of claim 21, wherein the use of the animation tool to combine the polygons of the lightweight format into a reduced mesh combines data from a plurality of objects into a single object.
